(19) United States
(12) Patent Application Publication
(10) Pub. No.: US 2010/0037723 A1
(43) Pub. Date: Feb. 18, 2010

(54) BICYCLE SHIFT CONTROL DEVICE

(76) Inventor: Douglas CHIANG, Taichung Hsieh (TW)

Correspondence Address: Chien-Hui Su, P. O. Box 70-121 Taichung, Taichung City, 40899, TW

(21) Appl. No.: 12/192,123

(22) Filed: Aug. 15, 2008

(51) Int. Cl. F16C 1/16

(52) U.S. Cl. 74/502

(57) ABSTRACT

A bicycle shift control device includes a release mechanism, a pulling mechanism, a sliding base connected to a cable adapted to be connected to a derailleur. The release mechanism includes a release base and a pushing member connected to a first pawl and a main pawl. The pulling mechanism includes a cable lever and a pulling rod connected to a second pawl. The sliding base has series of teeth for engaging with the first pawl, the main pawl, and the second pawl. When pulling the cable lever, the sliding base is driven to move by the second pawl to activate the up shift operation. When pressing the release base, the pushing member operates with the first pawl and the main pawl to activate the down shift operation.

### BACKGROUND OF THE INVENTION

1. Field of the Invention

The present invention relates to a shift device, and more particularly to a bicycle shift control device in that a compact, ergonomic, and low air resistance bicycle shift control device is acquired.

2. Description of Related Art

In general, a bicycle shift control device is mounted on a handle bar and connects to a bicycle front/rear derailleur via a cable. In an up shift operation, the bicycle front/rear derailleur is controlled by the bicycle shift control device to shift a chain from a small sprocket to a large sprocket. In a down shift operation, the bicycle front/rear derailleur is controlled by the bicycle shift control device to shift the chain from a large sprocket to a small sprocket.

In triathlons and time trials, the handle bar is different from the general handle bar. The handle bar for triathlons and time trials includes a pair of side handle bars which are in a shape of airfoil, a pair of front handle bars extending forwardly, and two brackets disposed in the intersections of the side handle bars and the front handle bars. The front handle bars are provided for hand gripping and the brackets are provided for arm resting. This riding posture advantages rider to minimize the air resistance. A conventional bicycle shift control device in accordance with the prior art comprises a lever directly connected to a cable for controlling a derailleur. The conventional bicycle shift control device is mounted in a front end of the front handle bar and controlled by rider's thumb. By turning the lever up or down relative to a supporting surface which supports the bicycle, the up shift or down shift operation is activated.

The operation of conventional bicycle shift control device is not ergonomic. Therefore the response time for operation is affected. Furthermore, the lever extends forwardly such that results more air resistance. The air resistance will affect the speed, and therefore this is disadvantageous for a cycling competition.

The present invention has arisen to mitigate and/or obviate the disadvantages of the conventional bicycle shift control device.

### SUMMARY OF THE INVENTION

The main objective of the present invention is to provide an improved bicycle shift control device in that a compact, ergonomic, and low air resistance bicycle shift control device is acquired.

To achieve the objective, the bicycle shift control device comprises a release mechanism, a pulling mechanism, and a sliding base.

The release mechanism connected to the sliding base comprises a release base, a pushing member, a first pawl, and a main pawl. One end of the pushing member connects to the release base and the other end of the pushing member selectively connects to the first pawl and the main pawl. The first pawl and the main pawl selectively connect to the sliding base.

The pulling mechanism connected to the sliding base comprises a cable lever, a pulling rod, and a second pawl. One end of the pulling rod connects to the cable lever and the other end of the pulling rod connects to the second pawl. The second pawl selectively connects to the sliding base

The sliding base connects to a cable adapted to be connected to a derailleur. The sliding has a first series of teeth and a second series of teeth both formed on a top thereof. The second series of teeth is parallel to the first series of teeth. Both the first series of teeth and the second series of teeth have multiple roots unequidistantly formed therein. The first series of teeth corresponds the operation of the first pawl and the main pawl. The second series of teeth corresponds the operation of the second pawl.

The pushing member is driven to move such that the first pawl engages with one of the roots and the main pawl disengages as pressing the release base. The first pawl disengages and the main pawl engages with one of the roots which is adjacent to the previous one as releasing the release base to activate the down shift operation. The second pawl engages with one of the roots to pull the sliding base toward the cable lever as pulling the cable lever to activate the up shift operation.

The pushing member and the pulling rod move linearly. Therefore the present invention is compact. The cable lever has a U-shaped cross section and is in a shape of curve. The cable lever is easy to manipulate and mates the human factor. Furthermore the shape of the cable lever minimizes air resistance. The usage of release mechanism for down shift operation and that of cable lever for up shift operation make the rider easy to understand the operation.

Further benefits and advantages of the present invention will become apparent after a careful reading of the detailed description with appropriate reference to the accompanying drawings.

### BRIEF DESCRIPTION OF THE DRAWINGS

FIG. 1 is an assembled perspective view of a bicycle shift control device in accordance with the present invention;

FIG. 2 is an exploded perspective view of the bicycle shift control device in FIG. 1;

FIG. 3 is a cross-sectional view of the bicycle shift control device taken along line 3-3 in FIG. 8;

FIG. 4 is a perspective schematic view of the bicycle shift control device which hides the housing;

FIG. 5 is a another perspective schematic view of the bicycle shift control device which hides the housing;

FIG. 6 is a is a cross-sectional view of the bicycle shift control device taken along line 6-6 in FIG. 8;

FIG. 7 is a partial top plane view of the bicycle shift control device in FIG. 4;

FIG. 8 is a front cross-sectional view of the bicycle shift control device;

FIG. 9 is an operational partial cross-sectional view of the bicycle shift control device shows the up shift operation;

FIG. 10 is an operational partial cross-sectional view of the bicycle shift control device shows the up shift operation;

FIG. 11 is an operational partial cross-sectional view of the bicycle shift control device shows the up shift operation;

FIG. 12 is an operational partial cross-sectional view of the bicycle shift control device shows the up shift operation;

FIG. 13 is an operational side schematic view of the bicycle shift control device shows the down shift operation;

FIG. 14 is an operational side schematic view of the bicycle shift control device shows the down shift operation; and

FIG. 15 is an operational side schematic view of the bicycle shift control device shows the down shift operation.

### DETAILED DESCRIPTION OF THE INVENTION

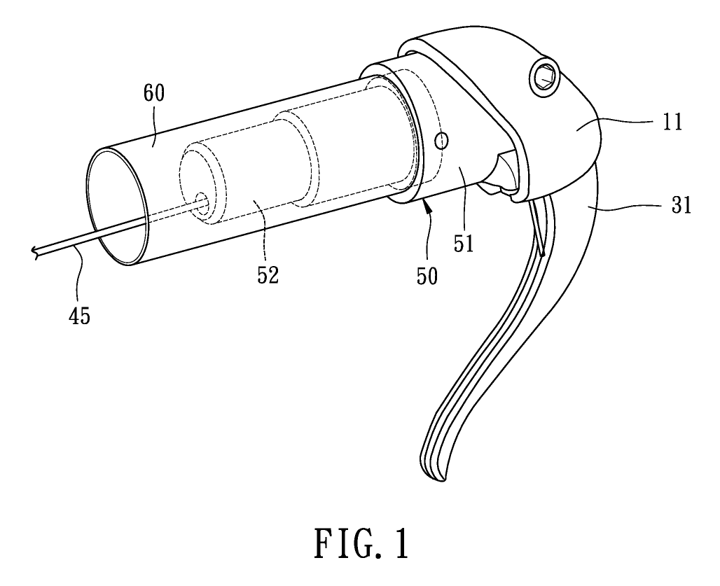

Referring to the drawings and initially to FIGS. 1-3, a bicycle shift control device in accordance with the present invention comprises a release mechanism 10, a pulling mechanism 30, a sliding base 40, and a housing 50. The release mechanism 10 and the pulling mechanism 30 are respectively connected to the sliding base 40 and partially received in the housing 50. The sliding base 40 is movable received in the housing 50 and connects to a cable 45 which is connected to a front/rear derailleur for activating the up shift operation or the down shift operation. The housing 50 is inserted into a handle bar 60 for partially concealing the bicycle shift control device.

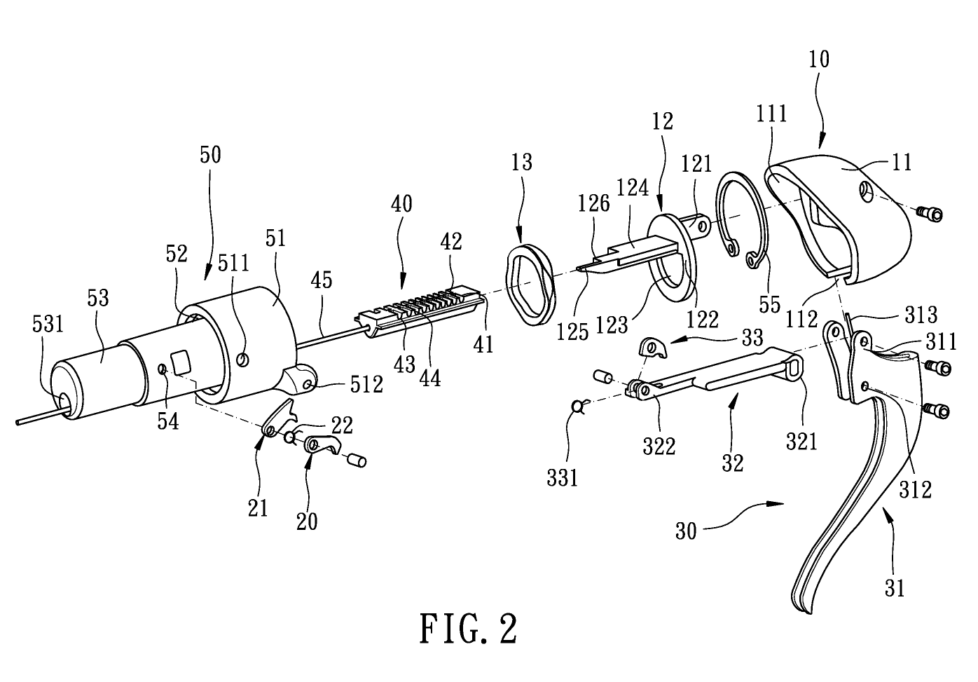

Referring to FIGS. 2-4, the release mechanism 10 includes a release base 11 sleeved on the housing 50, a pushing member 12 connected to the release base 11 and received in the housing 50, a first pawl 20 pivotally mounted in the housing 50, and a main pawl 21 pivotally mounted in the housing 50 and corresponding to the first pawl 20. The release base 11 is pressable and includes a cavity 111 defined therein for partially receiving the housing 50 and a slot 112 defined on a lateral of the cavity 111.

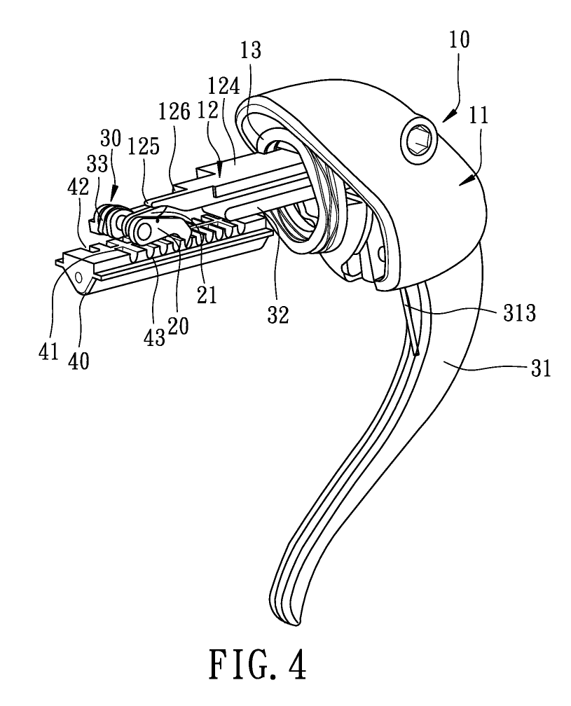

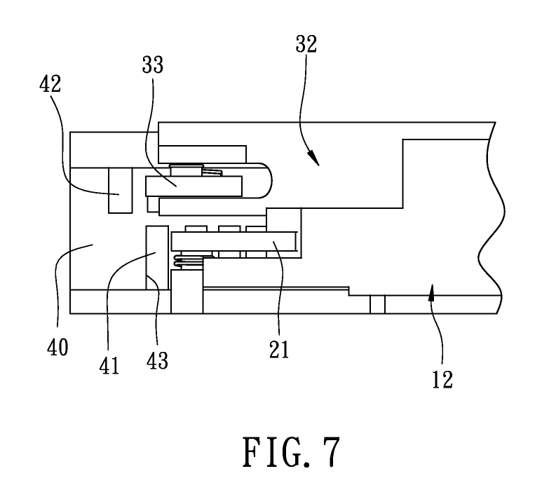

The pushing member 12 includes a connecting end 121 connected to the release base 11, a ring portion 122 perpendicular to the connecting end 121, and a pushing rod 124 longitudinally extending from the ring portion 122 opposite to the connecting end 121. In assembly, the connecting end 121 extends into the cavity 111 in the release base 11 and then is fixed with the release base 11 by a bolt (not numbered). Therefore, the pushing member 12 is driven and moved when pressing the release base 11. The ring portion 122 defines a through hole 123 facing the cavity 111 in the release base 11. The pushing rod 124 has an L-shaped structure longitudinally extending therefrom to form a first pushing end 125 and a second pushing end 126, as shown in FIGS. 4, 5, and 7. The first pushing end 125 and the second pushing end 126 respective have a taper underside. The directions of the taper underside of the first pushing end 125 and the second pushing end 126 are opposite each other and relative to the operation of the first pawl 20 and the main pawl 21 respectively. A wave spring 13 is disposed between the housing 50 and the ring portion 122 to bias the pushing member 12.

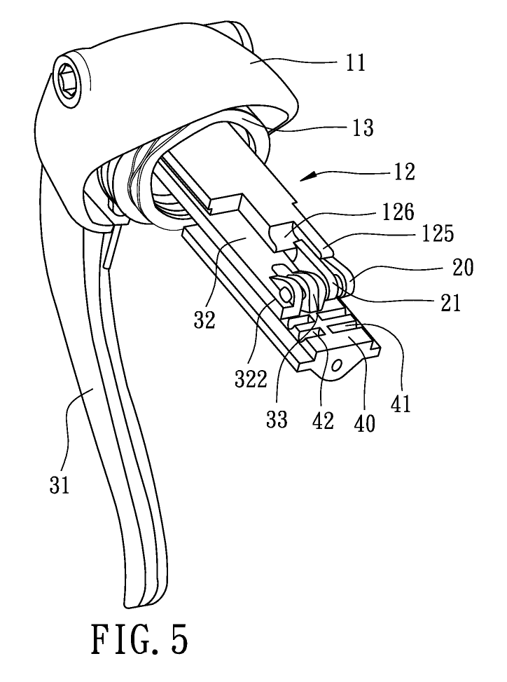

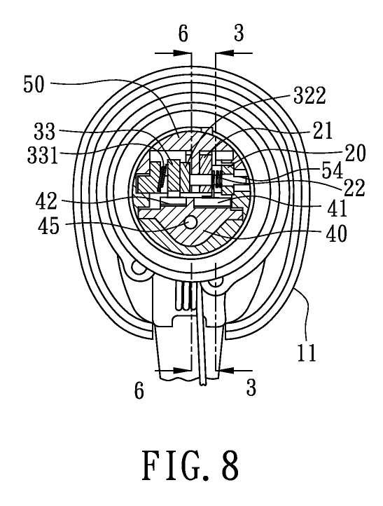

Referring to FIGS. 5 and 8, the first pawl 20 and the main pawl 21 are coaxially disposed in the housing 50 and connected to a torsion spring 22 each other to bias the main pawl 21 downwardly relative to a supporting surface which supports the bicycle. The first pushing end 125 and the second pushing end 126 respectively correspond to the first pawl 20 and the main pawl 21 to selectively contact with the pushing member 12.

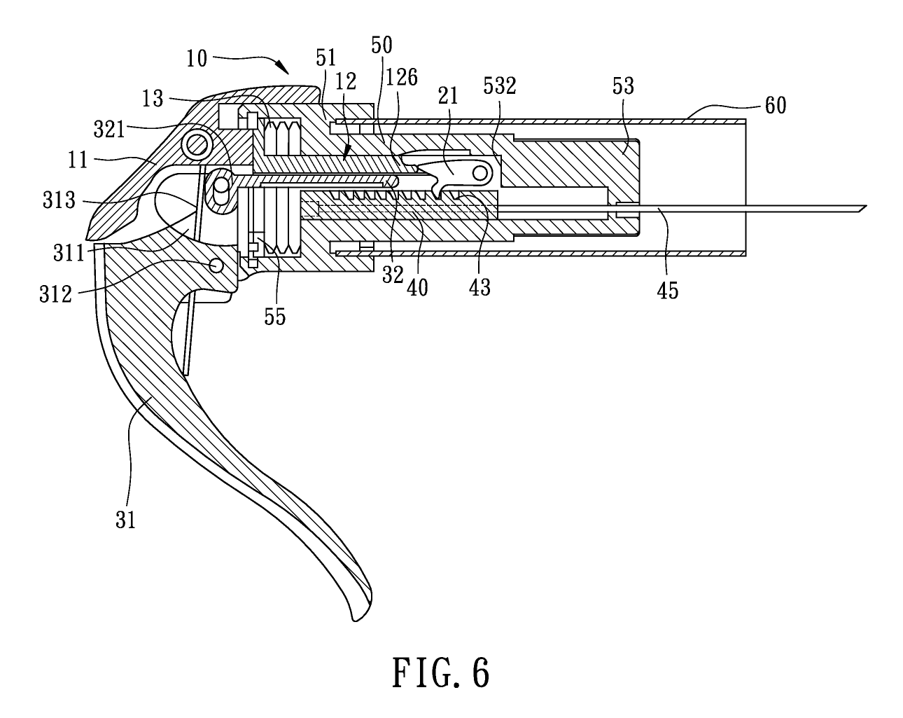

Referring to FIGS. 2, 5, and 6, the pulling mechanism 30 includes a cable lever 31 pivotally connected to the housing 50, a pulling rod 32 pivotally connected to the cable lever 31, and a second pawl 33 pivotally connected to the pulling rod 32. The cable lever 31 has a U-shaped cross section and is in a shape of curve. The cable lever 31 has a pair of ears 311 extending therefrom and a pair of pivotal holes 312 defined through the ears 311 for pivoting with the housing 50. A torsion spring 313 is disposed between the pivotal holes 312. The pulling rod 32 has a first end 321 and a second end 322 as shown in FIGS. 2, 5, and 7. The first end 321 is disposed between the ears 311 of the cable lever 31 and fastened by a pin or bolt. In assembly as shown in FIGS. 5 and 8, the pulling rod 32 passes through the through hole 123 in the pushing member 12. The ears 311 of the cable lever 31 pass through the slot 112 and partially conceal in the release base 11. The second end 322 has a pair of ears (not numbered). A torsion spring 331 and the second pawl 33 are disposed between the ears of the second end 322 and fastened by a pin or bolt. The torsion spring 331 is provided to bias the second pawl 33 downwardly relative to the supporting surface.

Referring to FIGS. 2, 3, and 8, the sliding base 40 has a first series of teeth 41 and a second series of teeth 42 both formed in a top thereof. The first series of teeth 41 corresponds to the first pawl 20 and the main pawl 21. The second series of teeth 42 corresponds to the second pawl 33. The second series of teeth 42 is parallel to the first series of teeth 41. Both the first series of teeth 41 and the second series of teeth 42 have multiple roots 43 and multiple crowns 44. Each pitch of two adjacent roots 43 is gradually increased/decreased.

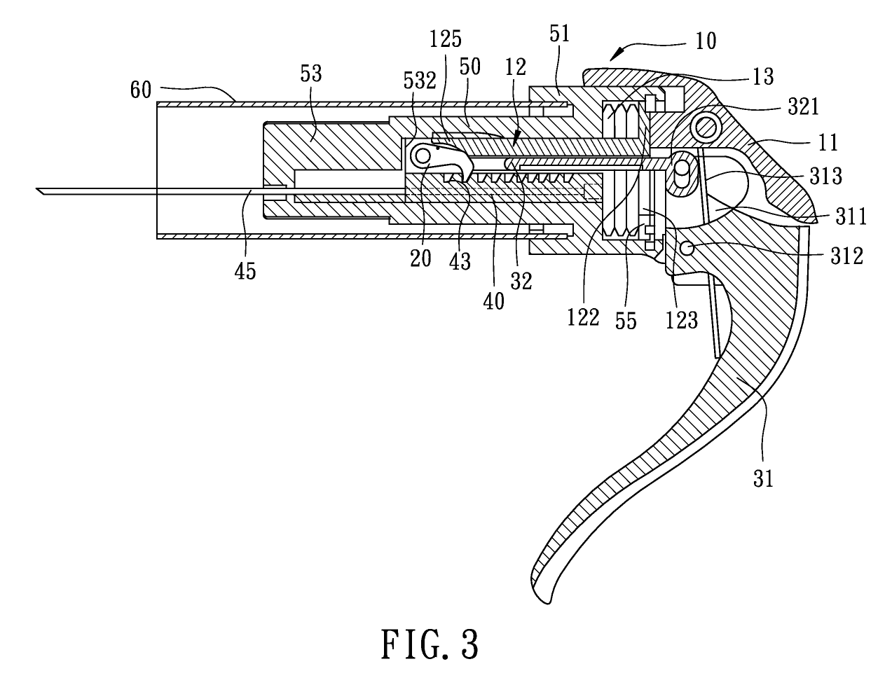

The housing 50 is cylindrical and hollow. The housing 50 is a one-piece structure or a multi-piece assembly. The housing 50 has a first end 51 and a second end 53 opposite to the first end 51. The first end 51 is diametrically wider than the second end 53. Referring to FIGS. 3 and 4, a C-ring 55 is disposed in an inner peripheral of the first end 51 of the housing 50 to block the ring portion 122 of the pushing member 12. The first end 51 has a positioning hole 512 defined in an outer peripheral thereof and corresponding to the pivotal holes 312 in the cable lever 31. In assembly, a pin or bolt sequentially passes through the pivotal hole 312, the torsion spring 313, and the positioning hole 512 to assemble the cable lever 31 and the housing 50. The cable lever 31 pivots around the positioning hole 512 and is biased by the torsion spring 313. After releasing the cable lever 31, the torsion spring 313 provides restitution force to restore the cable lever 31 to initial position. The first end 51 has a side hole 511 laterally extending therethrough. The housing 50 has an annular trough 52 disposed between the first end 51 and the second end 53. The second end 53 is inserted in to the handle bar 60 and a free end of the handle bar 60 is received in the annular trough 52. A pin or bolt passes through the side hole 511 and then fastens with the handle bar 60. The second end 53 has a shoulder 532 formed in an inner peripheral thereof, a cable hole 531 axially extending therethrough for passing the cable 45 through and a hole 54 disposed in an outer peripheral thereof. In assembly, the first pawl 20, the main pawl 21, and the torsion spring 22 are positioned in the housing 50 and aligned with the hole 54. A pin or bolt passes through the hole 54 and then fastens the first pawl 20, the main pawl 21, and the torsion spring 22. The cable 45 passes through the cable hole 531 and the sliding base 40 is received in the housing 50.

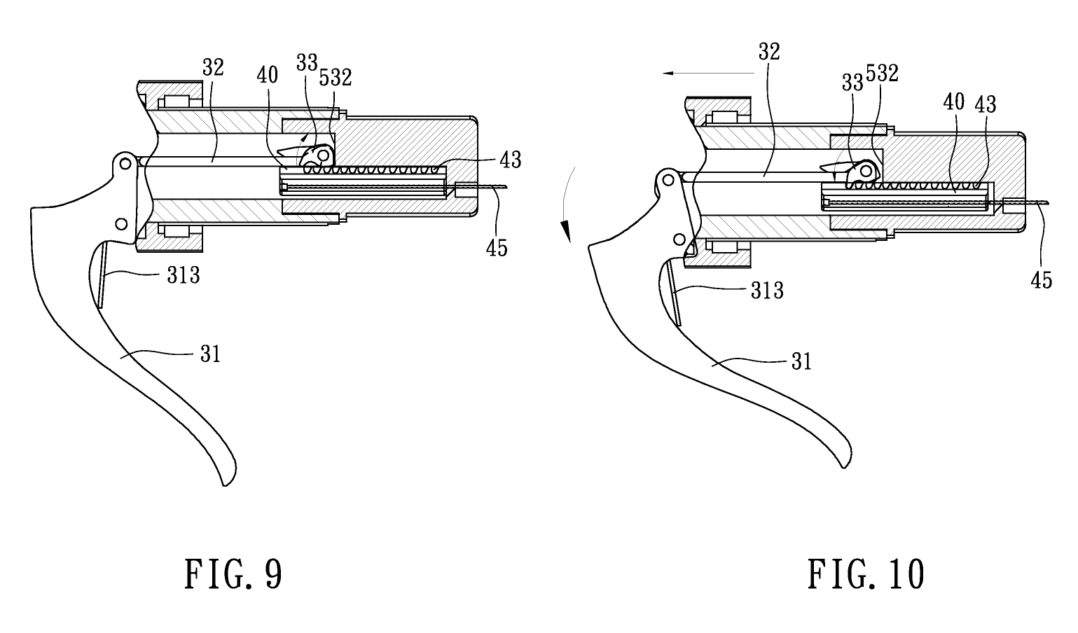

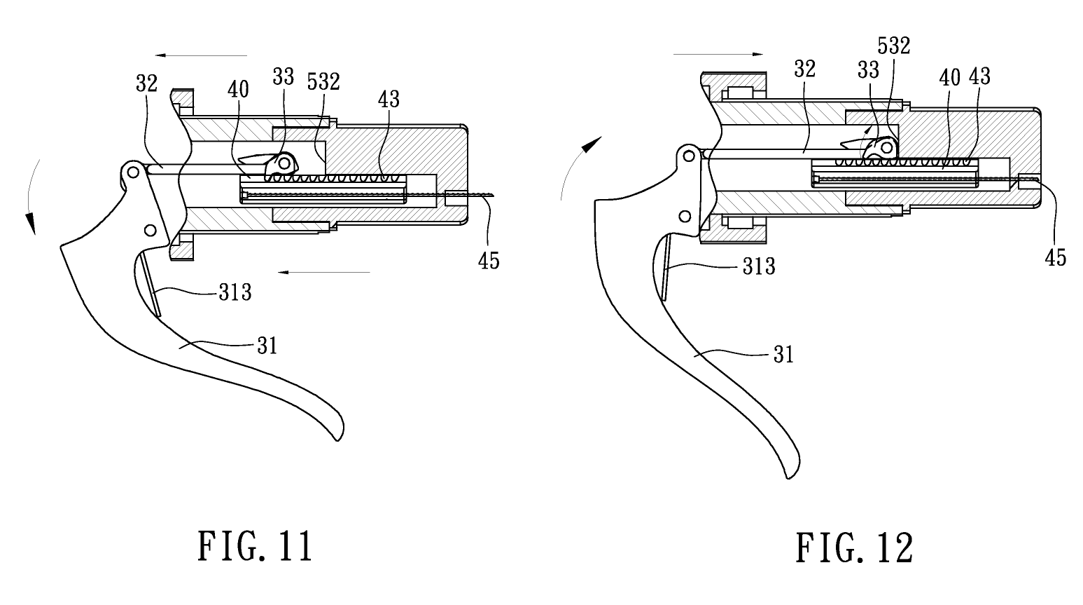

Referring to FIG. 9, the second pawl 33 is adjacent to the shoulder 532 and the second pawl 33 disengages with the root 43 of the second series of teeth 42 of the sliding base 40 in the initial state. When pulling the cable lever 31, the pulling rod 32 is driven and moved away from the shoulder 532, as shown in FIG. 10. Due to the resilient force of the torsion spring 331, the second pawl 33 is biased downwardly so as to engage with the root 43 of the second series of teeth 42. Therefore the sliding base 40 simultaneously moves with the pulling rod 32 as shown in FIG. 11. When releasing the cable lever 31, the cable lever 31 is biased to restore to the initial state as shown in FIG. 12. In the meanwhile, the pulling rod 32 is driven to move toward the shoulder 532 until the second pawl 33 is stopped by the shoulder 532. The second pawl 33 simultaneously disengages with the root 43 of the second series of teeth 42 and the main pawl 21 engages with the root 43 of the first series of teeth 41. The displacement of sliding base 40 toward the cable lever 31 causes the up shift operation.

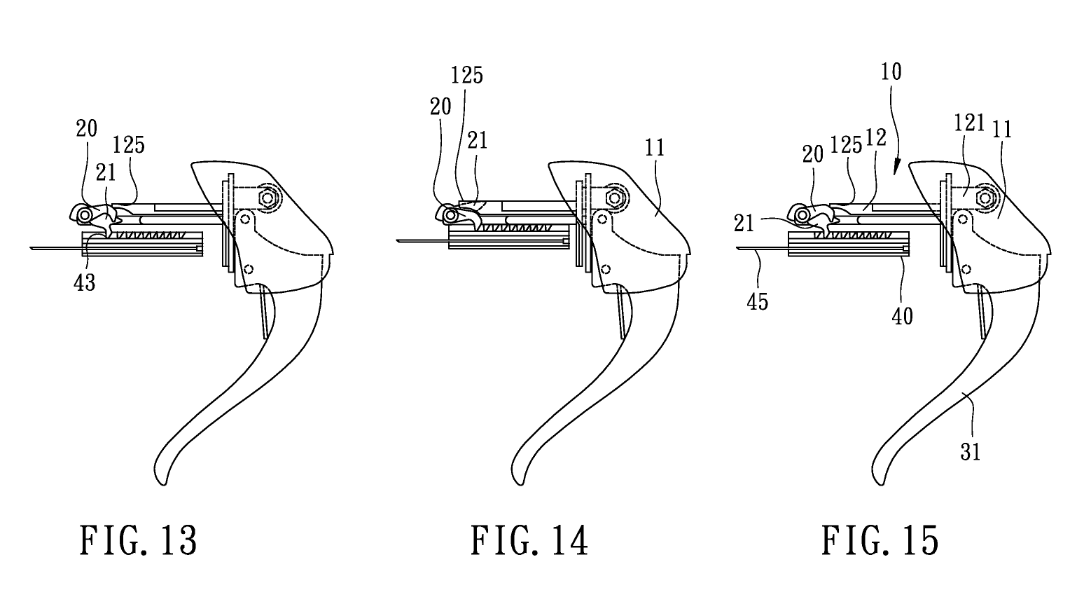

Referring to FIG. 13, the main pawl 21 engages with the root 43 of the first series of teeth 41 and the first pawl 20 is biased upwardly in the initial state. When pressing the release base 11, the wave spring 13 is compressed and the pushing member 12 is driven to move toward the main pawl 21. When the first pushing end 125 contacts with the first pawl 20, the first pawl 20 is pressed to engage with the root 43 of the first series of teeth 41 as shown in FIG. 14. In the meanwhile, the main pawl 21 also contacts with the second pushing end 126 and is raised to disengage with the root 43 of the first series of teeth 41. When releasing the release base 11, the pushing member 12 is subjected to the resilient force of the wave spring 13 to restore to the initial state. Therefore the first pushing end 125 and the second pushing end 126 respectively leave the first pawl 20 and the main pawl 21. In the meanwhile, the first pawl 20 is biased upwardly and the main pawl 21 is biased downwardly. The sliding base 40 is subjected to the tension from the derailleur to move away from the cable lever 31 at instance that the first pawl 20 disengages with the root 43. Therefore the main pawl 21 engages with the root 43 which is adjacent to the root 43 engaged in the initial state and along the direction toward the cable lever 31 as shown in FIG. 15. The displacement of sliding base 40 toward the direction opposite to the cable lever 31 causes the down shift operation.

Although the invention has been explained in relation to its preferred embodiment, it is to be understood that many other possible modifications and variations can be made without departing from the spirit and scope of the invention as hereinafter claimed.

What is claimed is:

1. A bicycle shift control device comprising:
a sliding base connected to a cable adapted to be connected to a derailleur, the sliding having a first series of teeth and a second series of teeth both formed on a top thereof, the second series of teeth being parallel to the first series of teeth, both the first series of teeth and the second series of teeth having multiple roots unequidistantly formed therein;
a release mechanism connected to the sliding base comprising:
a first pawl selectively connected to the sliding base, the first pawl selectively engaged with the first series of teeth;
a main pawl selectively connected to the sliding base, the main pawl selectively engaged with the first series of teeth;
a pushing member selectively connected to the first pawl and the main pawl; and
a release base connected to one end of the pushing member;
whereby the pushing member is driven to move such that the first pawl engages with one of the roots and the main pawl disengages as pressing the release base; the first pawl disengages and the main pawl engages with a corresponding one of the roots which is adjacent to the previous one as releasing the release base; and
a pulling mechanism connected to the sliding base comprising:
a second pawl selectively connected to the sliding base, the second pawl selectively engaged with the second series of teeth;
a pulling rod connected to the second pawl; and
a cable lever connected to one end of the pulling rod;
whereby the second pawl engages with one of the roots to pull the sliding base toward the cable lever as pulling the cable lever.

2. The bicycle shift control device as claimed in claim 1 further comprising a housing for receiving the sliding base and partially receiving the release mechanism and the pulling mechanism, the housing being in a shape of cylinder and hollow, the housing having a first end and a second end diametrically smaller than the first end, the first end connected to the cable lever, the first end having a side hole laterally extending therethrough, the housing having an annular trough disposed between the first end and the second end for receiving a handlebar, the second end having a shoulder formed in an inner peripheral thereof, a cable hole axially extending therethrough for passing the cable through, and a hole disposed in an outer peripheral thereof for passing a pin to pivotally connect the first pawl and the main pawl.

3. The bicycle shift control device as claimed in claim 1, wherein the release base connects one end of the pushing member, the release base having a cavity for receiving the pushing member and a slot for partially receiving the cable lever.

4. The bicycle shift control device as claimed in claim 3, wherein the pushing member has a connecting end connected to the release base, a ring portion perpendicular to the connecting end, and a pushing rod opposite to the connecting end, the pushing rod having an L-shaped structure longitudinally extending therefrom to form a first pushing end and a second pushing end, the first pushing end and the second pushing end respective having a taper underside, directions of the taper underside of the first pushing end and the second pushing end being opposite each other and relative to the operation of the first pawl and the main pawl respectively.

5. The bicycle shift control device as claimed in claim 4, wherein the cable lever has a U-shaped cross section and is in a shape of curve, the cable lever having a pair of ears extending therefrom and a pair of pivotal holes extending through the ears for pivoting with the housing.

6. The bicycle shift control device as claimed in claim 5, wherein the pulling rod has a first end connected to the ears of the cable lever and a second end connected to the second pawl.

7. The bicycle shift control device as claimed in claim 6, wherein the second end of the pulling rod connects the second pawl and a torsion spring, second pawl biased downwardly relative a supporting surface which supports bicycle by the torsion spring.

8. The bicycle shift control device as claimed in claim 1, the first series of teeth corresponds to the first pawl and the main pawl and the second series of teeth corresponds to the second pawl.
